(19) United States
(12) Patent Application Publication
(10) Pub. No.: US 2020/0171721 A1
(43) Pub. Date: Jun. 4, 2020

(54) APPARATUS AND METHOD FOR IN-MOLD SUBSTRATE BINDING TO ARTICLES MANUFACTURED BY INJECTION MOLDING

(71) Applicant: MI INTÉGRATION S.E.N.C., Sherbrooke (CA)

(72) Inventors: Yannick LONGPRÉ, Sherbrooke (CA); Nicolas NADEAU, Sherbrooke (CA); Jean THERRIEN, Sherbrooke (CA)

(21) Appl. No.: 16/615,517

(22) PCT Filed: Dec. 22, 2017
(86) PCT No.: PCT/CA2017/051591

§ 371 Date: Nov. 21, 2019

Related U.S. Application Data
(60) Provisional application No. 62/509,820, filed on May 23, 2017.

(51) Int. Cl. B29C 45/14; B29C 45/00

(52) U.S. Cl. CPC B29C 45/14065; B29C 45/26; B29C 45/0046

(57) ABSTRACT

Disclosed is an injection mold for manufacturing an injection-molded article to which a substrate is bound in-mold during injection, the substrate having an adhering surface for binding to the article and a leading edge at an upstream end of the substrate. The injection mold comprises a first mold component and a second mold component together defining a cavity into which a molten plastic material is injected to form the article. The injection mold includes a flow deflector disposed on at least one of the first and second mold components, wherein the flow deflector deflects a flow of the molten plastic material over the leading edge of the substrate such that the flow makes first contact with the substrate downstream of the leading edge, thereby forming a temporary air pocket at the leading edge of the substrate which is then back-filled by the subsequent flow of the molten plastic material.

### TECHNICAL FIELD

The present invention relates generally to injection molding and, more specifically, to apparatuses and methods for in-mold binding or over-molding of substrates onto molded articles.

### BACKGROUND

Injection molding is a manufacturing process in which a molten plastic material is injected into a mold cavity where it solidifies into a shape that conforms to the interior of the mold. Typically, the molten plastic material is a thermoplastic polymer or a thermosetting polymer.

The binding of substrates to injection-molded articles is typically done after the article has been molded which therefore requires additional manufacturing steps that are costly, time-consuming and which may pose a number of challenges especially when manufacturing objects with irregular shapes or when using noxious chemicals to promote adherence.

In-mold binding of the substrate onto a molded article presents a number of advantages but also a number of challenges. One problem resides in the positional stability of the substrate during injection. Injection molding requires that the molten thermoplastic be injected at very high pressure. The molten thermoplastic flow exerts a force on the substrate that can easily displace the substrate inside the mold. Binding of a tape onto a molded article is one example of a particularly challenging operation. Immobilization of the substrate in the mold by clamping the substrate, for example, may result in the clamping structure(s) creating discontinuities in the articles. However, without mechanically immobilizing the substrate, the molten plastic material can easily seep underneath the substrate, displacing it, deforming it or otherwise creating imperfections in the finished product that are unacceptable given the stringent specifications required in many industries.

One example of in-mold binding of a substrate is in-mold labeling. U.S. Pat. No. 7,140,857 (Graham) discloses a technique for in-mold labeling in which a label ledge is provided for injection molding of containers. The ledge protects the leading edge of the in-mold label from the flow of resin under certain conditions. Because the leading edge of the label is protected under certain conditions, the resin flows over the leading edge of the label and secures the label to the cavity wall of the mold, creating a container with a label formed on the container wall. However, due to its geometry (and in particular its obtuse angle) the ledge only adequately functions to divert the resin over the leading edge when the viscosity and injection conditions enable a sufficient resin flow velocity. If the injection conditions and/or the viscosity of the resin do not enable the velocity of the flow to be sufficiently high, the ledge will not prevent the resin from contacting the leading edge of the label. In such cases, the label is susceptible to being displaced and/or deformed by the resin.

In certain applications, in-mold substrate binding involves a substrate that has relatively delicate functional structures such as flock tape. Attempting to in-mold bind flock tape may lead to flock fiber flattening and disruption of its appearance and functionality. In such cases, secondary operations, like brushing for example, to straighten the fibers back into position are required. Not only do these secondary operations constitute additional costs but may also remove flock coating sometimes applied to the fibers to improve their properties (anti-freeze for example).

There is therefore a need in the molding industry for an improved method and apparatus to address the technical problems identified above associated with in-mold substrate binding.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

One aspect of the invention is an injection mold for manufacturing an injection-molded article to which a substrate is bound in-mold during injection, the substrate having an adhering surface for binding to the article and a leading edge at an upstream end of the substrate. The injection mold comprises a first mold component and a second mold component together defining a cavity into which a molten plastic material is injected to form the article. The injection mold includes a flow deflector disposed on at least one of the first and second mold components, wherein the flow deflector deflects a flow of the molten plastic material over the leading edge of the substrate such that the flow makes first contact with the substrate downstream of the leading edge, thereby forming a temporary air pocket at the leading edge of the substrate which is then back-filled by the subsequent flow of the molten plastic material.

Another aspect of the invention is an injection mold assembly for manufacturing an injection-molded article to which a substrate is bound in-mold during injection, the substrate having an adhering surface for binding to the article, and flock-fibers on a surface opposite the adhering surface, the injection mold assembly comprising: a first mold component and a second mold component together defining a cavity into which a molten plastic material is injected to form the article; a plurality of fiber-receiving channels in a bottom side of a substrate cavity located in one of the first and second mold components wherein the substrate is placed in the substrate cavity such that at least some of the fibers are within the plurality of fiber-receiving channels during injection.

In yet another aspect of the invention is a method of injection-molding an article to which a substrate is bound in-mold during injection, the substrate having an adhering surface for binding to the article and a leading edge at an upstream end of the substrate. The method entails providing a first mold component and a second mold component together defining a cavity, injecting a molten plastic material into the cavity to form the article and deflecting a flow of the molten plastic material over the leading edge of the substrate using a flow deflector deflects such that the flow makes first contact with the substrate downstream of the leading edge, thereby forming a temporary air pocket at the leading edge of the substrate which is then back-filled by the subsequent flow of the molten plastic material.

Other aspects of the invention may become apparent from the detailed description and drawings.

### BRIEF DESCRIPTION OF THE DRAWINGS

The invention will be better understood by way of the following detailed description of embodiments of the invention with reference to the appended drawings, in which:

FIG. 1 is a cross-sectional view of a molten plastic material flowing inside a portion of an injection mold.

FIG. 2 is a cross-sectional view of an injection mold having a flow deflector having an overhang in accordance with an embodiment of the invention.

FIG. 3 is a cross-sectional view of an injection mold having the flow deflector of FIG. 2 wherein the substrate is shorter than the substrate cavity.

FIG. 4 is a cross-sectional view of an injection mold having no substrate cavity in accordance with another embodiment of the invention.

FIG. 5 is a cross-sectional view of an injection mold having a flow deflector shaped like a rounded lip in accordance with another embodiment of the invention.

FIG. 6 is a cross-sectional view of an injection mold of FIG. 5 depicting the impingement of the molten plastic material onto the substrate downstream of the leading edge.

FIG. 7 is a cross-sectional view of an injection mold having a flow deflector shaped like a ramp in accordance with yet another embodiment of the invention.

FIG. 8 is a cross-sectional view of an injection mold of FIG. 4 except that the substrate is shorter than the recess into which it is placed.

FIG. 9 is a cross-sectional view of an injection mold having a flow deflector having an undercut as a flow deflector in accordance with a further embodiment of the invention.

FIG. 10 is a cross-sectional view of an injection mold having a dual angled ramp as a flow deflector in accordance with a further embodiment of the invention.

FIG. 11 is a cross-sectional view of an injection mold having a flow-directing structure in accordance with another embodiment of the invention.

FIG. 12 is a cross-sectional view of an injection mold having a movable flow-directing structure in accordance with another embodiment of the invention.

FIG. 13 is a cross-sectional view of an injection mold having a movable flow deflector in accordance with another embodiment of the invention.

FIG. 14 is a cross-sectional view of an injection mold having a vacuum source as a substrate stabilizer in accordance with another embodiment of the invention.

FIG. 15 is a cross-sectional view of an injection mold having an angled injection port in accordance with another embodiment of the invention.

FIG. 16 is a cross-sectional view of an injection mold having a stepped flow deflector in accordance with another embodiment of the present invention.

FIG. 17 is a cross-sectional view of an injection mold having a substrate retention member in accordance with another embodiment of the invention.

FIG. 18A is a cross-sectional view of an injection mold having a plurality of flock receiving channels in accordance with another embodiment of the invention.

FIG. 18B is a cross-sectional view of an injection mold having a plurality of obliquely angled flock receiving channels in accordance with another embodiment of the invention.

FIG. 19A is a cross-sectional view of an injection mold having a mesh structure that provides the flock receiving channels.

FIG. 19B is a cross-sectional view of an injection mold having a mesh structure that provides the flock receiving channels in which strands of the mesh are rounded at the top.

FIG. 20 is a top view of laser-cut flock receiving channels.

FIG. 21 is a side view of the laser-cut flock receiving channels.

FIG. 22 is a cross-sectional view of an injection mold having a mesh structure that provides the flock-receiving channels and further having a vacuum-based retention system in accordance with another embodiment of the invention.

FIG. 23A is a photomicrograph of flocking fibers on a flock tape.

FIG. 23B is a photomicrograph of flocking fibers on a flock tape that has been exposed to in-mold binding while resting on a mesh of 150 mesh size.

FIG. 23C is a photomicrograph of flocking fibers on a flock tape that has been exposed to in-mold binding while resting on a mesh of 180 mesh size.

FIG. 23D is a photomicrograph of flocking fibers on a flock tape that has been exposed to in-mold binding while resting on a mesh of 250 mesh size.

It will be noted that throughout the appended drawings, like features are identified by like reference numerals.

### DETAILED DESCRIPTION

Disclosed herein is a novel injection mold (or injection mold system) for manufacturing a molded article having a substrate bound thereto. By bound it is meant that the substrate adheres permanently to the article or is otherwise over-molded on the article to become integral therewith. The substrate thus becomes permanently and integrally bound to the article within the mold as the molten plastic material, such as thermoplastic or thermoset, is injected and deposited on the substrate and subsequently cooled or cured to form the molded article.

The substrate can be any type of material that can be over-molded or adhered to the molded article in the injection conditions. The substrate may exhibit various shapes and at least a substantial part of it is usually bound to the surface of the molded article. One example of a substrate is a tape. Tapes may serve esthetic or functional purposes in many types of applications. Tape having flocking fibers on one of its sides is such an example.

Thus, by substrate it is meant a material that comprises at least one adhering surface which contacts and binds to the molded article. The substrate also has an outside (non-bound) surface and edges.

Generally, the outside (non-bound) surface of the substrate is facing the (bottom) surface of the mold. During the injection, the molten plastic material, e.g. thermoplastic, fills the cavity and, in the process, is deposited onto the adhering surface of the substrate (molded article contacting surface of the substrate). Depending on the molded article structure and the relative position of the substrate, one or more edges of the substrate, in particular the upstream or leading edge, may be exposed to the incoming front of the flow of the molten thermoplastic within the mold during injection. This head-on encounter between the front of the flow of molten plastic (e.g. melted thermoplastic) and the edge of the substrate can easily displace the substrate by the pressure exerted on the edge. Additionally, the edges of a substrate are almost never perfectly lined up with the surface of the mold creating discontinuities or gaps and the front of the flow can easily seep underneath the substrate through these gaps.

These technical problems are overcome by the new injection mold disclosed herein which has a flow deflector configured to deflect the flow of molten plastic material over a leading edge of the substrate. Having made first contact with the substrate downstream of the leading edge, the flow (an “edge directional flow”) of the molten plastic material forms a temporary air pocket (temporary dead zone) between the leading edge of the substrate and this point of first contact with the substrate. The molten plastic material flows from a central area of the adhering surface of the substrate towards the one or more edges, including rearwardly to back fill the temporary air pocket. The flow deflector thus prevents the front of the flow from coming into contact head-on with an edge of the substrate. Thus, in one embodiment, the injection mold comprises mating mold components that define an interior space or cavity designed to provide the desired shape for the molded article and further comprising a flow deflector for creating an edge directional flow such that deposition of the molten plastic material on the substrate happens downstream of the leading edge of the substrate. The flow, subsequent to first contact with the substrate, then proceeds from a generally central area of the adhering surface of the substrate towards one or more edges of the substrate. The “edge directional flow”, as this expression is used herein, means a flow of molten plastic material that moves in a direction toward an edge or periphery of the substrate from an initial point of contact on the substrate that is distal from the edge or periphery.

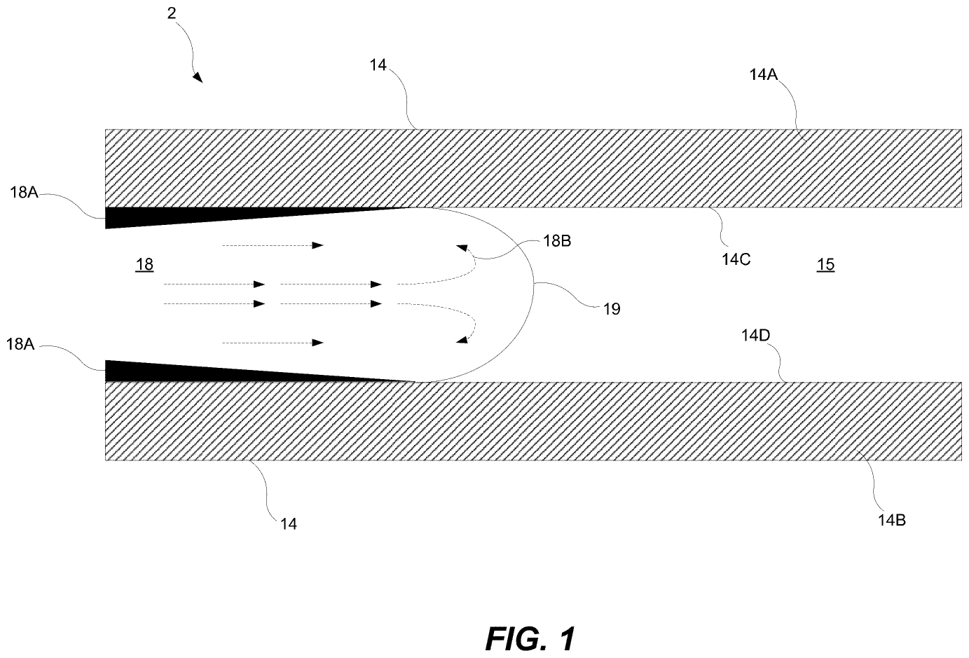

In at least some embodiments, as depicted conceptually in FIG. 1, the flow deflector exploits the naturally occurring rearward curl that is referred to as “fountain flow”. In an injection mold system 2 having a mold 14 formed by a first mold component 14A and a second mold component 14B defining a cavity 15, the flow 18 of molten plastic material such as thermoplastic is believed to be characterized, in some cases, by an advancing front 19 having a generally parabolic profile as shown in FIG. 1. An outer concentric portion of the flow congeals prematurely along the first and second mold surfaces 14C, 14D as “frozen layers” that solidify due to the slightly lower temperature of the first and second mold surfaces 14C, 14D relative to the molten plastic material. These “frozen layers” are denoted by reference numeral 18A. The curls defining the “fountain flow” denoted by reference numeral 18B are exploited by the flow deflector in at least some embodiments of this invention to generate a backflow that back-fills the temporary air pocket that is formed downstream of the flow deflector and upstream of the point of first contact of the flow on the substrate.

It will be appreciated that the present invention is also compatible with other kind of flows such as completely laminar flows for example. Furthermore, the flow may also be multi-vectorial meaning that there may be more than one propagation front travelling in different directions and different velocities depending on the characteristics of the mold.

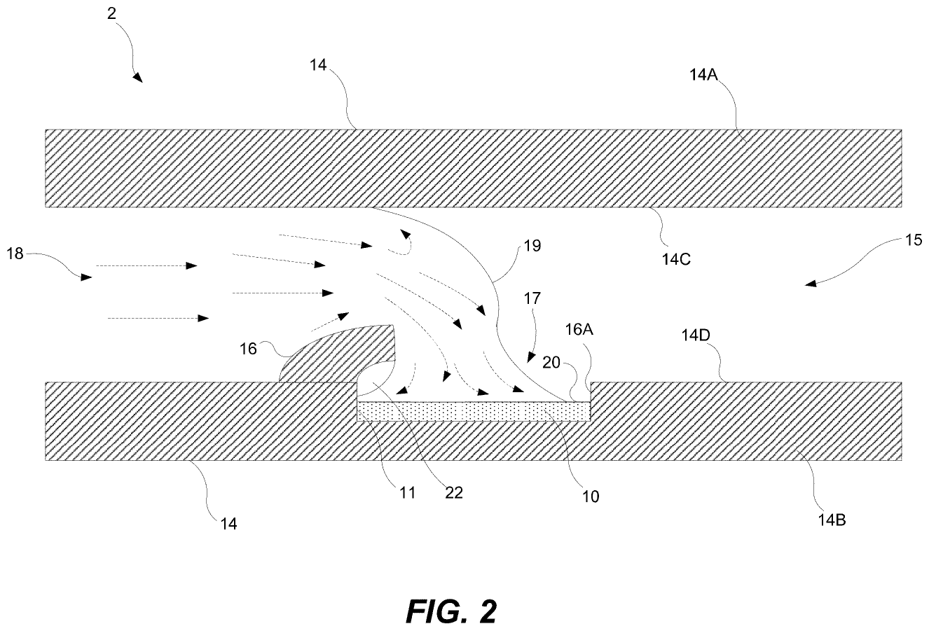

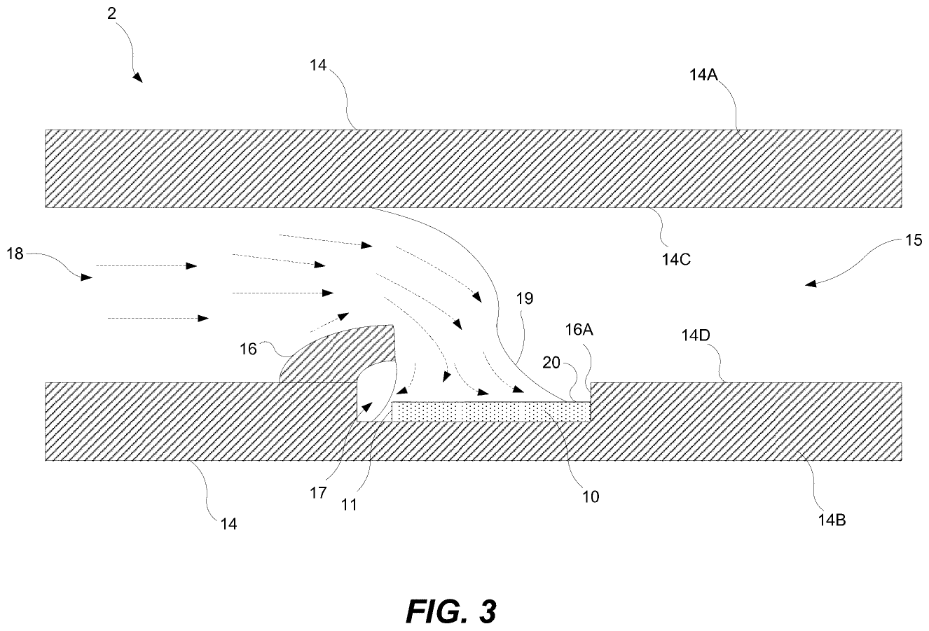

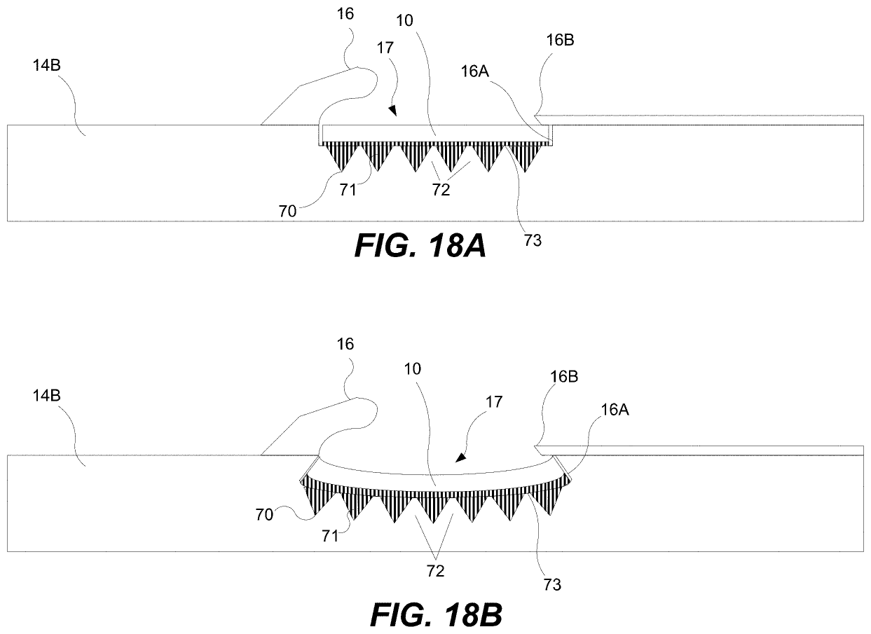

In the embodiment depicted by way of example in FIG. 2, an injection mold (or injection molding system or injection molding apparatus) designated generally by reference numeral 2 is designed to bind a substrate 10 to an article (or object) being molded within a cavity 15 of a mold 14. The mold 14 is shown partially and in cross-section in FIG. 2. In this example, the mold has an upper mold component 14A (i.e. a first mold component) and a lower mold component 14B (i.e. a second mold component). The upper and lower mold components 14A, 14B have smooth interior surfaces that respectively define a first molding surface 14C and a second molding surface 14D. These molding surfaces are illustrated with an arbitrarily flat shape although it will be appreciated that these molding surfaces may have any suitable contours, curves, shapes or geometry to mold a desired part. The lower mold component 14B includes an optional substrate cavity 17 (i.e. a recess) for receiving the substrate 10. In the embodiment depicted in FIG. 2, the injection mold has a flow deflector 16. The main function of the flow deflector 16 is to deflect or divert a flow 18 of molten plastic material so as to prevent the front 19 of the flow 18 from contacting the leading edge(s) of the substrate 10 head-on. The flow deflector 16 instead deflects the flow 18 so that the front 19 of the flow 18 makes first contact with the adhering surface 20 of the substrate 10 downstream of the leading edge 11. The molten plastic material flows backward toward the leading edge, which is referred to herein as “an edge directional flow”. The edge directional flow is created in part by the flow deflector 16 and in part by the dynamic of the molten plastic flow within the mold. In the embodiment depicted in FIG. 2, the flow deflector 16 includes an overhang (or overhanging structure) that extends rearwardly over the substrate cavity 17 to deflect the flow of molten thermoplastic inside the mold over the leading edge of the substrate 10 in the substrate cavity 17. The positioning of the overhang over the cavity and the substrate (in other words the dimension of the overhang) is optimized as a function of the leading edge 11 position relative to the flow deflector and the side wall of the substrate cavity 17. As can be seen in FIGS. 3 and 18A for example, there can exist a small gap between the leading edge and the wall of the substrate cavity. This gap, when present, may vary as a function of the tolerance in the specifications of the length or width of the substrate such as a tape (that is to say normal variations in the dimensions of a tape within a production batch or between batches). The overhang (and flow deflector 16) dimensions are preferably optimized by taking into account the variations in the size of the gap created by the tolerance (variations in dimensions) in the manufacture of the substrate. Therefore the flow deflector 16 should extend over the substrate cavity by an amount that will ensure that it also extends over the substrate by a predetermined minimum amount even when the dimension of the substrate vary slightly between different injection runs. In the case of tape such as flock tape for automotive applications, the length of the overhang that is immediately above the tape is preferably between about 0.03 mm and 0.3 mm.

The flow deflector 16 may have a curved front surface as shown in this figure. This flow deflector 16 guides the flowing molten thermoplastic over the leading edge 11 of the substrate 10 so that the molten thermoplastic first contacts the adhering surface 20 downstream of the leading edge i.e. contacts a central portion of the substrate 10 that is distal from the leading edge 11 prior to flowing back toward the leading edge 11. Without wishing to be bound by theory, it is believed that, when a fountain flow is generated, the curl of the fountain flow helps to generate the backflow that backfills the temporary air pocket 22. In the embodiment shown in FIG. 2, the substrate 10 is disposed within the recess or substrate cavity 17 formed in the lower mold component 14B defined between the flow deflector 16 and a rear wall 16A. Although the substrate 10 is shown as having the same length (or width) as the recess of the lower mold component 14B, and thus fitting exactly within the recess, it will be appreciated that a smaller substrate 10 may be placed within the recess in variants of this technique as shown in the embodiment depicted in FIG. 3, where the substrate 10 is shorter than the substrate cavity 17. In this particular embodiment, the downstream end of the flow deflector 16 is substantially aligned with the leading edge 11 of the substrate 10, although it is not necessary that these be aligned in other embodiments and variants. In this embodiment, the flow deflector 16 deflects the flow 18 over the leading edge 11 onto the substrate 10. Substrates that are slightly smaller than the cavity may be easier to position in the mold prior to the injection. The gap created between the wall of the substrate cavity and the leading edge 11 may be small and allowing very little or virtually no melted thermoset to seep in. In other embodiments the gap may actually form part of the structure of the final molded article but the leading edge 11 is still protected, by flow deflector 16, from a head on impact with the front of flow 18 since the gap will be filled by an edge directional flow. Although the flow 18 in this figure is illustrated as generally unidirectional, it will be appreciated that the flow 18 is multidirectional in most cases, i.e. the flow may also be perpendicular or oblique to the main flow direction shown in the figure.

While 14B is referred as the lower mold component, it will be appreciated that it refers to the part of the mold that receives the substrate and that the mold may be oriented vertically in some applications.

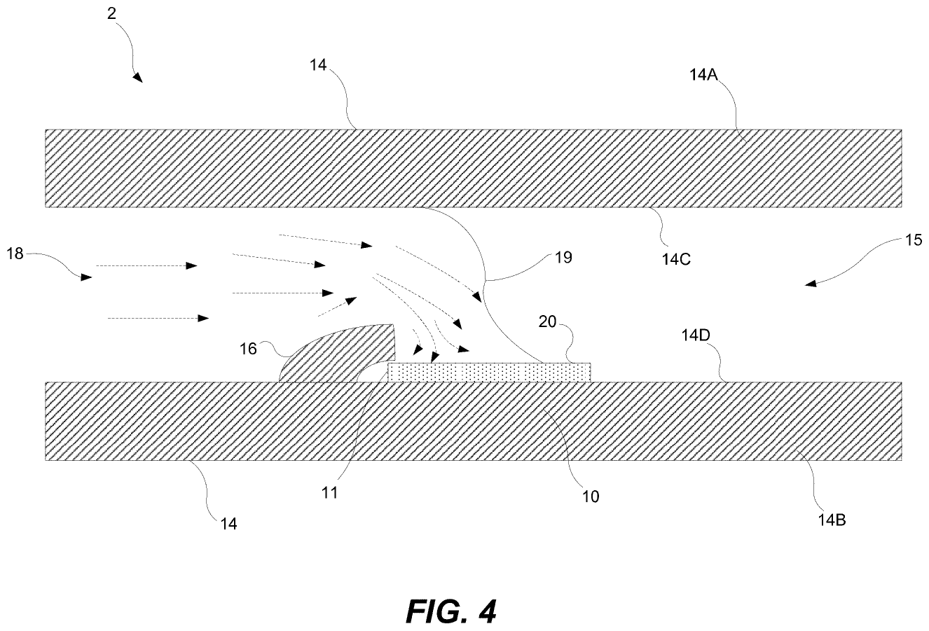

In the embodiment depicted in FIG. 4, the injection mold 2 does not have a substrate cavity to receive the substrate. Instead, the substrate 10 rests directly on the second molding surface 14D. In this embodiment, the flow deflector 16 also deflects the flow 18 over the leading edge 11 onto the substrate 10.

The behavior of molten plastic material (whether thermoplastics or thermosets) under different conditions of temperatures and pressures is complex and is generally understood to be dependent on the physico-chemical properties of the molten plastic material. In particular, the viscosity of the molten plastic material under the conditions at which the injection is performed is important to consider in optimizing the process. Furthermore, the flow may exhibit an uneven velocity distribution within a given cross-section of the flow. As was illustrated in FIG. 1, the central or middle portion of the flow typically exhibits a greater velocity than the sections that are closer to the walls of the mold. Therefore, when the flow of molten plastic material encounters a change in the structure of the mold the slower portions of the flow tend to follow the contour of the walls of the mold while the central or middle portion of the molten thermoplastic material tends to flow where the least resistance is encountered.

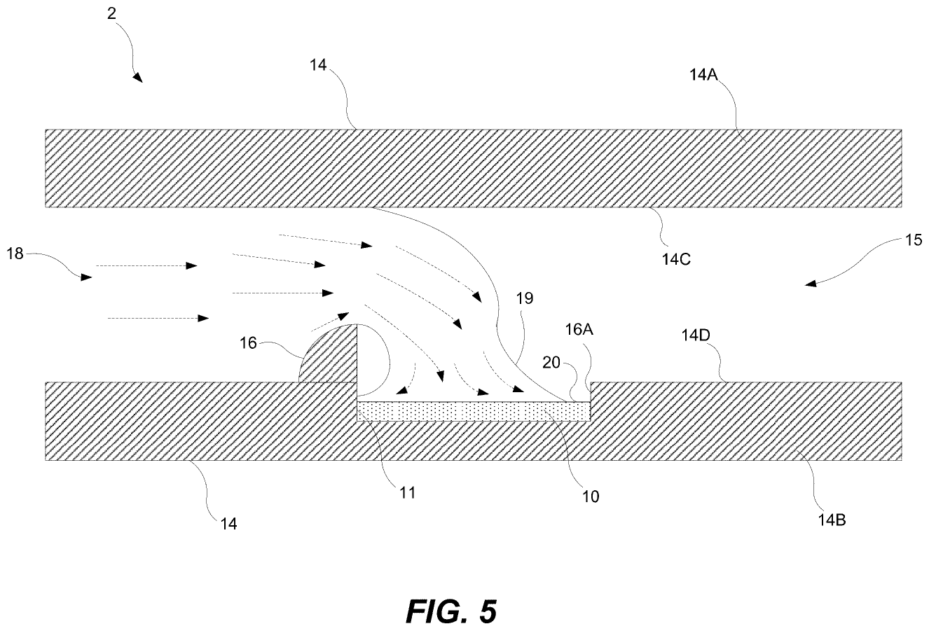

In the embodiment depicted in FIG. 5, the flow deflector 16 is a ramp-like lip or ridge extending orthogonally from the lower mold component 14B toward the upper mold component 14A. In the particular embodiment depicted in FIG. 5, the ramp-like flow deflector 16 is a rounded or curved lip or ridge. The rounded lip may have a constant curvature or a variable curvature or it may have one or more portion of constant curvature and one or more portions of variable curvature. The upstream side of the flow deflector 16 of FIG. 5 may be curved or rounded as shown. The downstream side of the flow deflector 16 may be flat or straight as shown. It will be appreciated that this geometry may be varied in other embodiments. In the embodiment shown in FIG. 5, the flow deflector 16 is a lip-like structure or ridge-like protrusion that extends substantially orthogonally to the direction of flow, i.e. in a direction that is orthogonal to the planes defined by the first molding surface 14C and the second molding surface 14D.

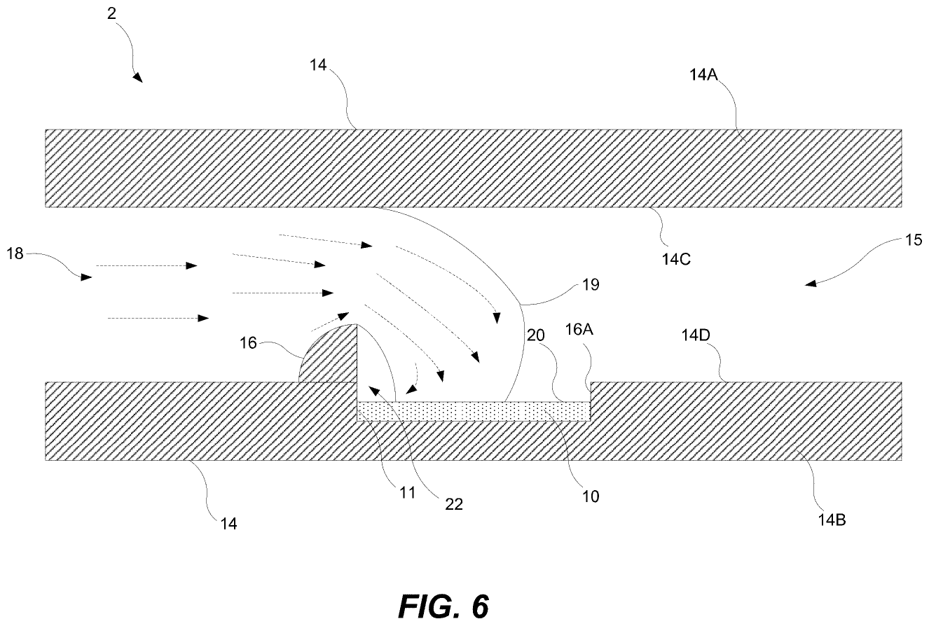

The flow deflector 16 is positioned and shaped to deflect the flow of molten plastic material away from the second molding surface 14D so that the molten plastic material avoids contact with the leading edge 11 of the substrate 10 that is immediately downstream of the flow deflector 16. The molten plastic material travels over the flow deflector 16 to create what is termed herein a “temporary dead zone” or temporary air pocket 22. This temporary air pocket 22 is formed immediately downstream of the flow deflector 16. The air pocket is temporary because it is back-filled by the flow of molten plastic material. In other words, due to the flow deflector 16, an air pocket 22 is temporarily formed straddling the junction or interface between the leading edge 11 of the substrate 10 and the downstream side of the flow deflector 16 such that substantially none of the molten plastic material flows head-on onto the leading edge 11 of the substrate 10. Thus, unlike prior-art injection molding techniques, the molten plastic material does not follow the contour of the mold to impinge upon the leading edge of the substrate. Instead, the molten plastic material is deflected over the leading edge 11 of the substrate 10 and makes first contact with the substrate 10 downstream of the leading edge 11. The molten plastic material that makes first contact with the substrate thus exerts an initial securing pressure on a central part of the substrate to thereby initially immobilize the substrate. Immediately thereafter, due to the continuous inflow, the molten plastic material flows toward the edges of the substrate. The flow of the molten plastic material is both forward and rearward. In other words, part of the molten plastic material flows in a generally forward direction toward a downstream edge of the substrate while another portion of the molten plastic material flows rearwardly (upstream) to back-fill the temporary air pocket. This is illustrated in FIG. 6. Thus, the expressions “temporary dead zone” and “temporary air pocket” are meant to refer to a volume or space within the mold that is adjacent an upstream edge of the substrate and immediately downstream of the flow deflector that remains temporarily empty or free of molten plastic material despite the immediate surroundings being filled by the molten plastic material. The temporary dead zone or temporary air pocket is eventually filled by the molten plastic material but in a directionally controlled manner by which the flow of molten plastic material travels from a generally central area of the adhering surface of the substrate towards the edge(s) or periphery of the substrate. As such, the temporary dead zone or temporary air pocket 22 is a collapsing space that progressively diminishes as the molten plastic material flows backward toward the leading edge 11.

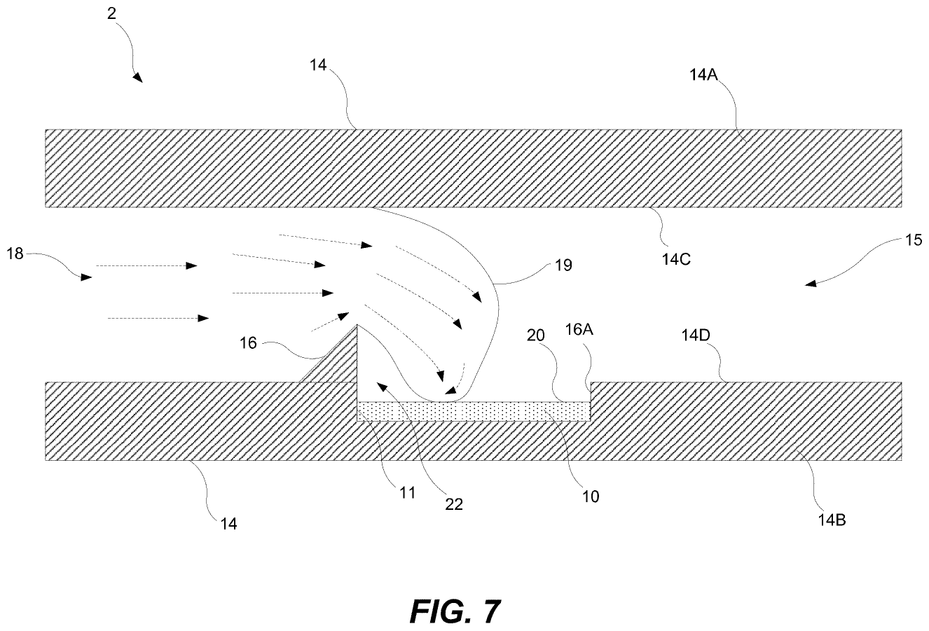

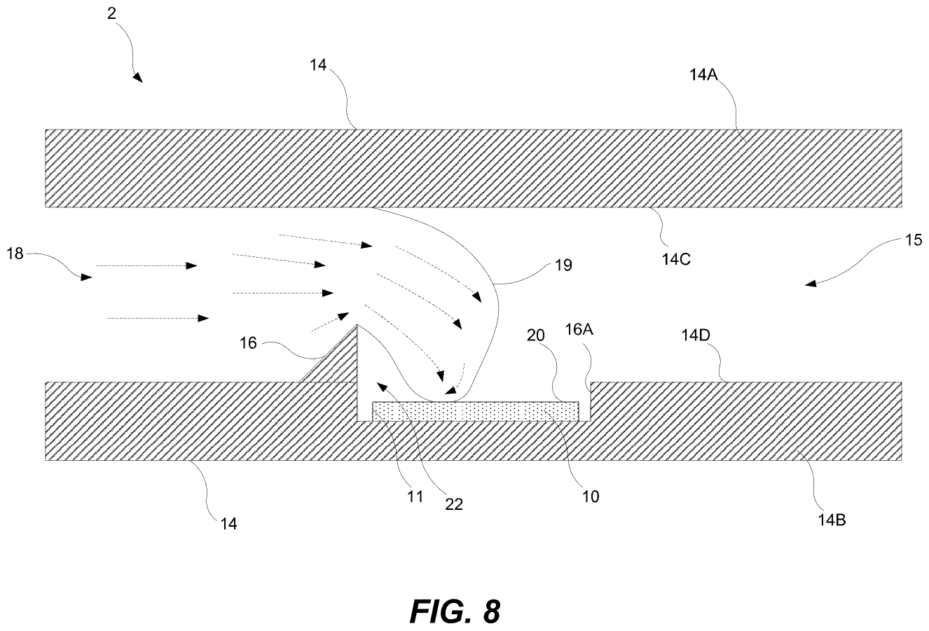

The creation of a temporary dead zone 22 (i.e. a shrinking pocket of empty space) along the leading edge 11 of the substrate 10 is dependent on several factors as mentioned above. The shape of the flow deflector 16 can be optimized to provide a desired size of temporary dead zone 22. One such embodiment is depicted in FIG. 7 in which the flow deflector 16 has a linear ramp shape. The shape of the flow deflector 16 can be altered to situate the point of first contact of the molten plastic material on the substrate 10. In some cases, it may be desirable to have the molten thermoplastic material make first contact with the center point of the substrate 10. In some embodiments, the substrate 10 is shaped to fit exactly within the recess in the lower mold component 14B. In other words, in these embodiments, the length (or width, depending on the shape of the substrate) of the substrate 10 is equal to (or slightly less than) the length of the recess. In other embodiments, as depicted by way of example in FIG. 8, the substrate 10 can be shorter than the recess, i.e. the length of the substrate 10 is less than the length of the recess. In this embodiment, the overmolding can cover the front and rear faces of the substrate 10.

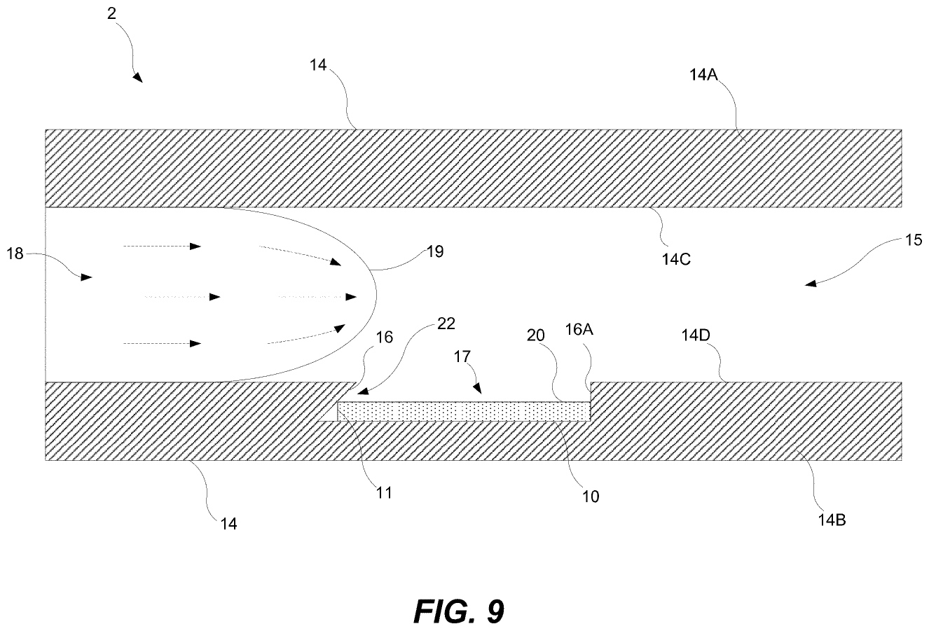

Another embodiment of the injection mold is shown in FIG. 9 in which the flow deflector 16 is formed as an angled undercut under which the leading edge of the substrate 10 may be disposed. The undercut is designed to create the temporary dead zone especially with higher viscosity thermoplastics or in conditions where the flow velocity is particularly slow. Such an undercut may also contribute to maintaining the substrate 10 in position by preventing it from lifting up. In a specific embodiment, the upstream edge (leading edge) 11 of the substrate 10 may be gently wedged into the angular space formed by the undercut so that the upstream edge (leading edge) 11 of the substrate 10 is physically restrained.

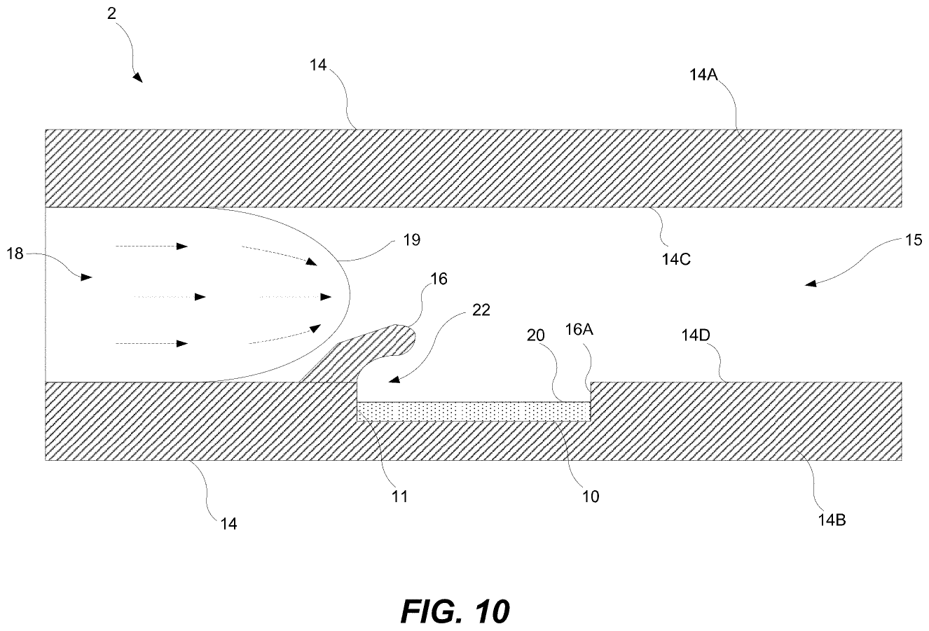

It will be appreciated that the flow deflector 16 may exhibit different shapes and features to optimize the dynamic of the flow according to particular conditions, type of substrate, physico-chemical properties of the molten plastic material or other relevant factors. Another embodiment of the injection mold 2 is shown in FIG. 10. In the embodiment shown in FIG. 10, the injection mold 2 has a dual angled flow deflector 16 that has a first angled ramp-like portion having a first angle and a second angled ramp-like portion having a second angle different from the first angle.

It will be appreciated that while the flow characteristics of different types of molten plastic materials may differ, the embodiments of the invention described above can be applied or adapted to the injection molding of various thermoplastics and thermosets.

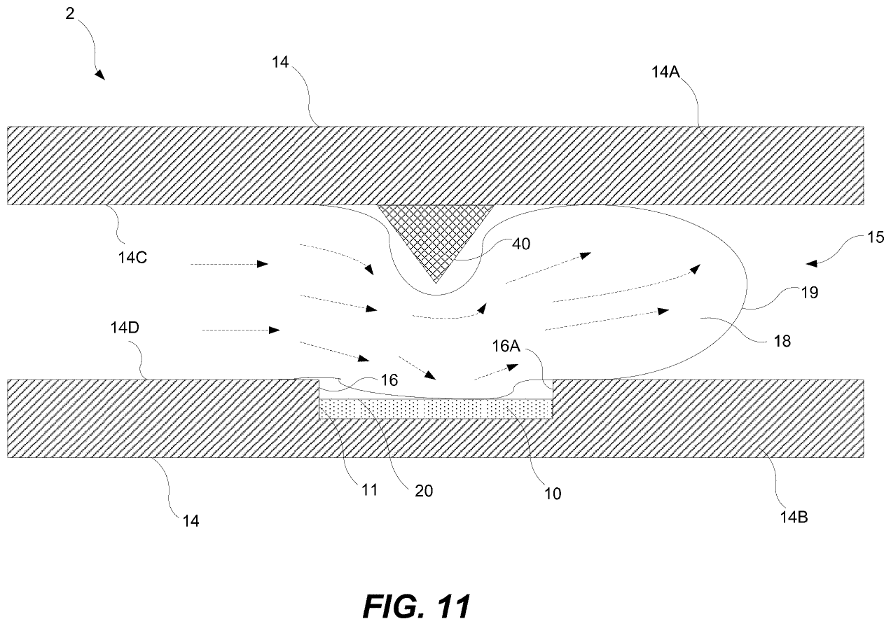

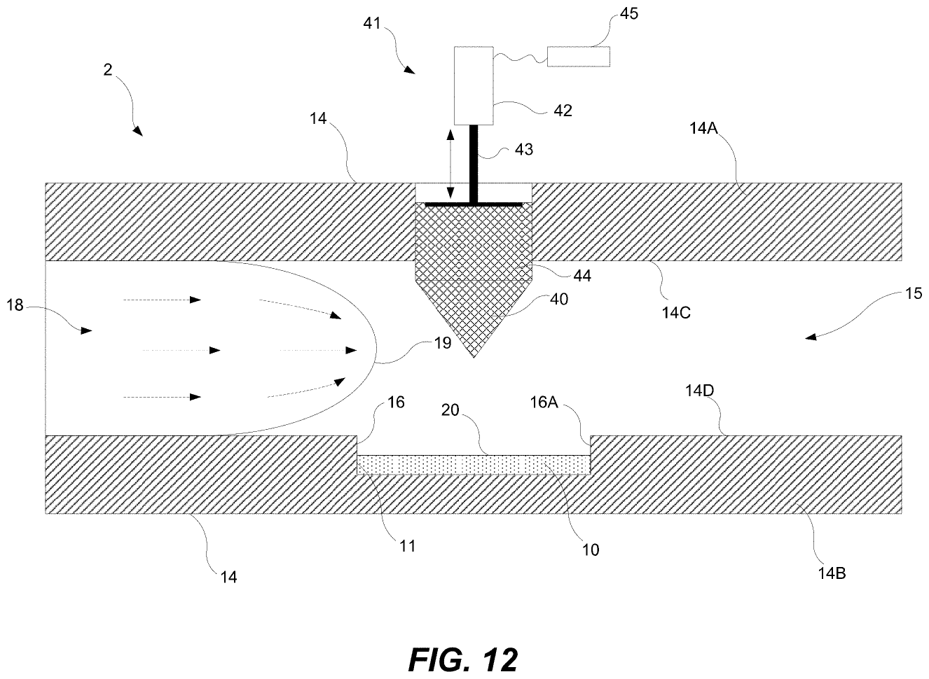

In the embodiments depicted by way of example in FIGS. 11 and 12, the injection mold 2 may include one or more flow-directing structures 40 attached to, or integrated into, the mold to direct and optimize the flow over the substrate 10. As shown in the embodiment of FIG. 11, the injection mold 2 includes a single flow-directing structure 40 protrudes from an upper mold component 14A to force the flow of molten plastic material onto a desired section of the substrate 10, e.g. a generally central portion of the substrate. In the example shown in FIG. 11, the flow-directing structure 40 is disposed on a first side of the mold opposite to a second side of the mold that receives the substrate. Specifically, in the embodiment depicted in FIG. 11, the flow-directing structure 40 protrudes from the upper mold component 14A toward the lower mold component 14B. In the embodiment depicted in FIG. 11, the flow-directing structure 40 is substantially aligned with a midpoint of the substrate 10 although in other variants the flow-directing structure 40 is not aligned with the midpoint of the substrate and thus may be upstream or downstream of the midpoint of the substrate. In other embodiments, there may be more than one flow-directing structure 40 which may have the same size and size or different sizes and different shapes.

The flow deflector 16 and the flow-directing structure 40 may be retractable or otherwise dynamically displaceable during the injection in order to optimize the flow and/or reduce the impact of the presence of these structures on the finished article. FIG. 12 depicts an example of a retractable or movable flow-directing structure 40. In the embodiment depicted in FIG. 12, the injection mold 2 includes a retraction mechanism 41 for moving (i.e. extending and retracting) the movable flow-directing structure 40. The retraction mechanism 41 may extend from and retract into the upper mold component 14A as shown by way of example in FIG. 12. The retraction mechanism 41 may be driven by, for example, a hydraulic actuator 42 having a rod 43 connected to an insert 44 that is mounted to the flow-directing structure 40. The insert 44 may have one or more seals or gaskets to slide tightly inside the bore in the upper mold component 14A. The actuator 42 is controlled in this embodiment by a controller 45.

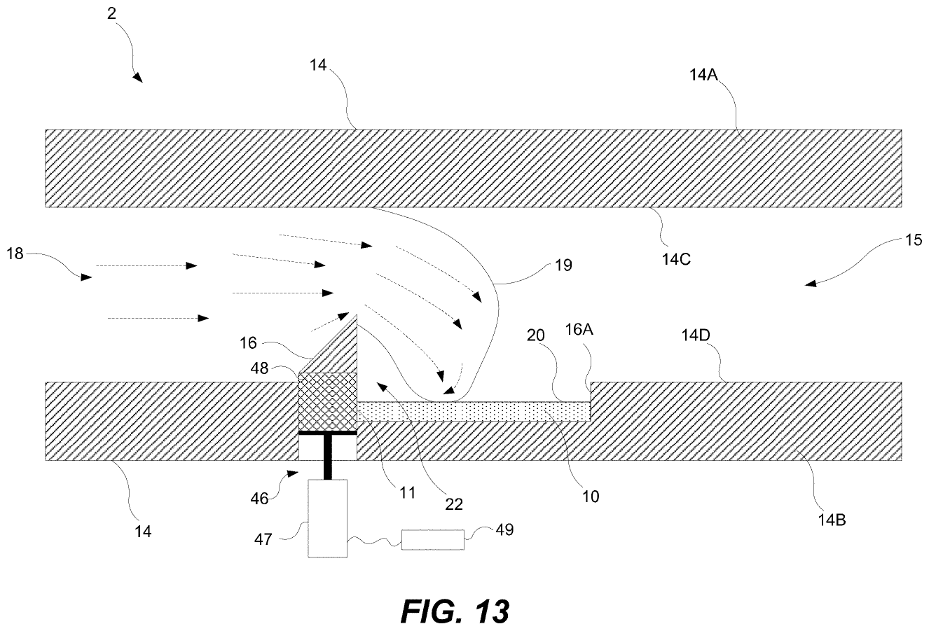

FIG. 13 depicts an injection mold 2 having a movable flow deflector 16. The movable flow deflector 16 is extended and retracted by a retraction mechanism 46 that includes an actuator 47 that drives a slidable insert 48. The actuator 47 in this embodiment is controlled by a controller 49.

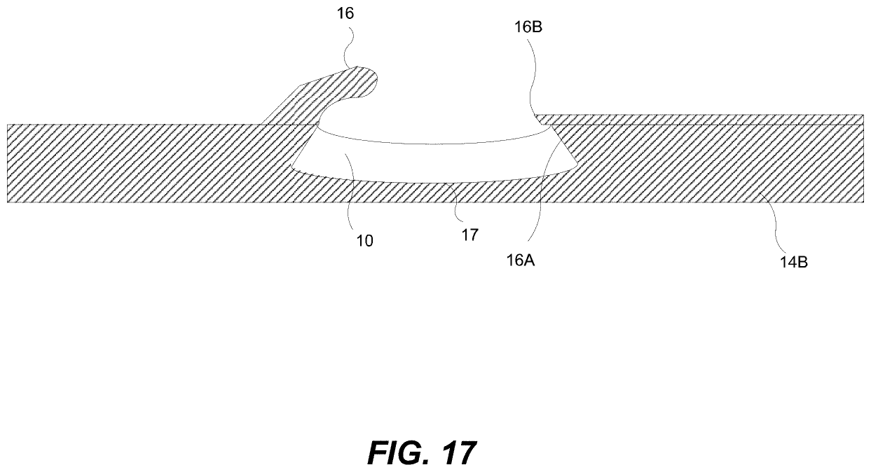

Small variations in the positioning of the substrate 10 within the injection mold 2 prior and during injection may result in disruption of molten thermoplastic deposition on the substrate 10. In this respect, substrate position stabilizing means (or substrate stabilizer) to help to maintain the position of the substrate 10 is optionally provided. In one aspect and as shown in FIG. 17, rear wall 16A may comprise a substrate retention member 16B to prevent the substrate from being pushed out or lifted up of the substrate cavity 17 or to prevent warping or wrinkling of the substrate as the flow exert pressure on it. The shape and size of substrate retention member 16B are adapted according to a number of factors including the shape of the substrate cavity 17, the thickness of the substrate, the flow pressure, viscosity of the melted thermoset and the like. FIG. 17 depicts an embodiment in which the substrate cavity 17 is curved and the substrate retention member 16B protrudes slightly from rear wall 16A above substrate 10 enough to prevent the substrate from being pushed out or lifted up from substrate cavity 17. It will be appreciated that the size of the substrate retention member 16B is configured to minimize disruption of the structure of the object being molded. Other configurations for the substrate retention member 16B are also possible. For example it could be positioned at an intermediate location between the bottom and the top of rear wall 16A.

The substrate retention member 16B may also serve to enable the use of a vertical mold (in which the plane defined by the junction of the upper mold component and lower mold component is oriented vertically). In such a case, the retention member 16B, optionally cooperatively with the flow deflector 16, prevents the substrate from falling off due to gravity while it is being position in the mold prior to closing the mold and proceeding with the injection.

The positional stability of the substrate 10 may also be enhanced by exerting a force on the substrate 10. The force may be applied prior to the injection and maintained during the injection cycle or applied only during pre-determined segments of the injection cycle. In one aspect the force may be applied while positioning the substrate in the mold prior to injection.

Thus, the substrate stabilizer may, for example, exert a stabilizing force on the substrate 10 by application of a vacuum or partial vacuum, an electrostatic force, a magnetic force or a mechanical force.

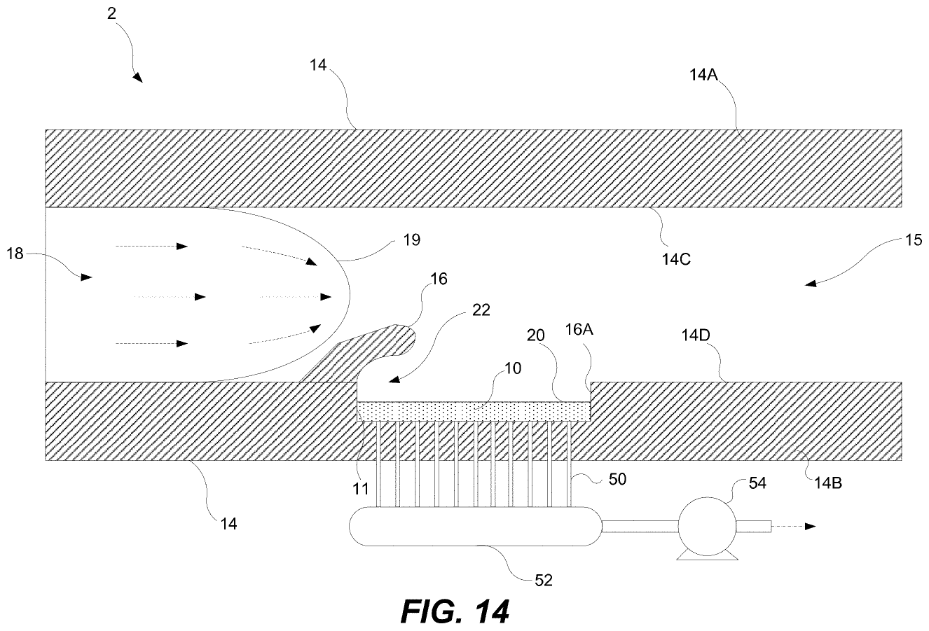

As depicted by way of example in FIG. 14, when a vacuum is used as the stabilizing means, multiple vacuum channels 50 in the lower mold component 14B where the substrate 10 is positioned are connected to a vacuum tank 52 that is evacuated fully or partially by a vacuum source such as a vacuum pump 54 to create suction (downward pressure) on the substrate 10.

The use of a force as a substrate stabilizing means may be combined with a structural component stabilizer such as the substrate retention member 16B. Together they can cooperatively stabilize the substrate or act separately at different stages of the molding process.

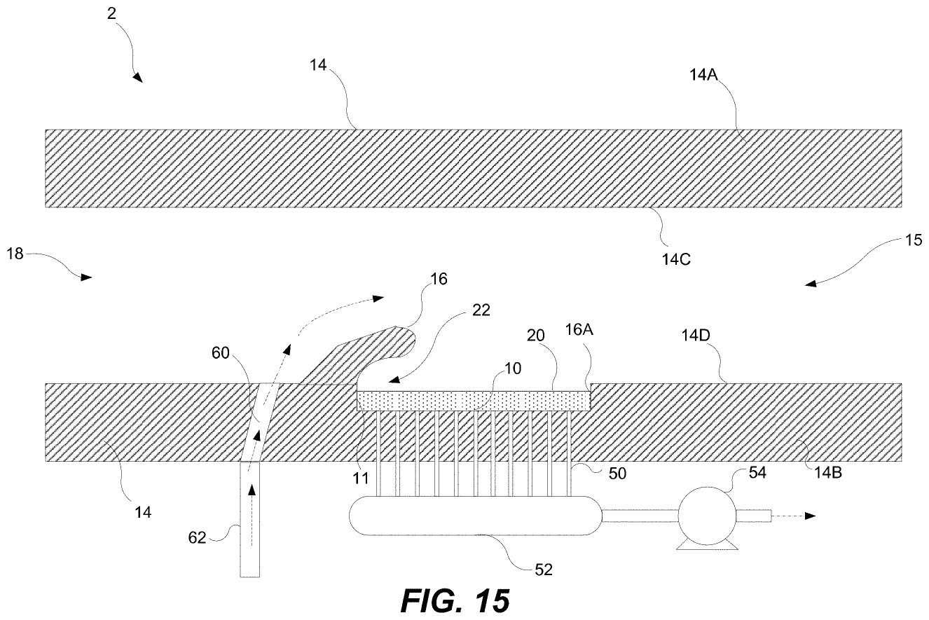

In yet another embodiment of the invention, the injection mold 2 includes an angled injection port 60 as depicted in FIG. 15 to obliquely inject molten plastic material into the mold cavity 15. The angled injection port 60 may be disposed at an angle to optimize the path of the molten plastic material so that the material flows over the leading edge 11 of the substrate 10.

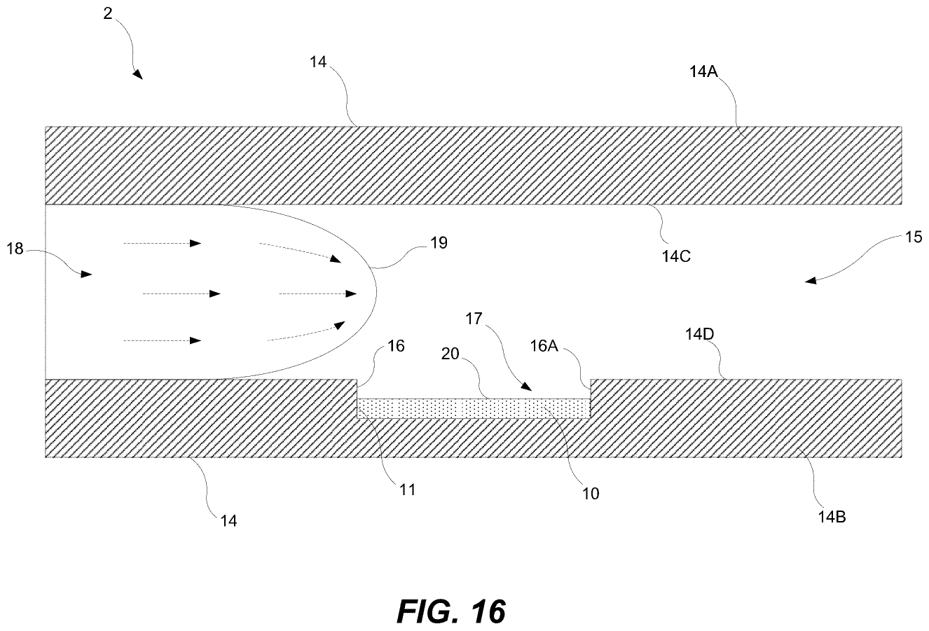

In the embodiment depicted by way of example in FIG. 16, the flow deflector 16 comprises a step. The stepped flow deflector is substantially orthogonal to the flow of molten thermoplastic inside the mold as shown in the figure. The flow deflector 16 has a height or depth (i.e. “thickness”) extending in an orthogonal direction that is greater than that of the substrate 10 such that there is a stepwise gap between the interface of the flow deflector 16 and the second molding surface 14D and the adhering surface 20 of the substrate 10. The rear wall 16A may have the same height or “thickness” as the flow deflector 16 although in other variants, the rear wall 16A may differ in height or shape.

In the case of a relatively high-viscosity thermoplastic, the shape and size of the flow deflector 16 of FIG. 16 may be adjusted to have a more accentuated stepwise shape to prevent the head-on contact between the slower part of the front of the flow and the edge of the substrate. In this embodiment, the flow deflector 16 is designed to substantially prevent the flow from penetrating underneath the substrate at its leading edge through spaces at the interface between the edge of the substrate and the side of the flow deflector 16.

In some applications, the substrate may be a tape comprising a functional structure on the side that is not bound to the molded object. For example flock tape (a tape with flocking fibers on the non-adherent side), which is often used in the automotive industry to provide functionalities such as sealing, noise reduction, reduced friction and the like. The stringent specifications in industries in general and the automotive industry in particular require that functional structures such as the flocking fibers on flock tape remain essentially intact or at least that any alterations to the fibers be limited to a strict minimum compatible with proper function of the part comprising the tape.

The conditions within the mold can be harsh for the substrate as a result of the high pressures involved. These harsh conditions may result in damage to functional structures of substrates. In the case where the substrate is flock tape, damage can be in the form of flattening of the fibers as a result of the pressure exerted by the flow of the melted thermoset and/or by the substrate stabilizing means (vacuum for example). Thus in another aspect of the invention there is provided a flocking fibers protective structure whereby the fibers of the flock are substantially protected from flattening while sufficient support is provided to maintain the shape of the substrate (tape) during injection.

Referring to FIG. 18A an exemplary embodiment is schematically represented in which a plurality of flock fibers receiving channels 70 are embedded in lower mold component 14B just underneath the substrate positioning area which, in some instances, coincides with substrate cavity 17. The flock receiving channels 70 are dimensioned to accommodate the length of flocking fibers 71 with some extra space at the bottom to allow for variations in length of the fibers and/or slight downwards displacement of the tape when subjected to the pressure of the flow of melted thermoset. Thus the depth of the flock receiving channels 70 may be, for example, between about 0.2 and 1 mm, a range comprising typical length of flock fibers. The extra space at the bottom may be of the order of about 10-20% of the length of the flock fibers.

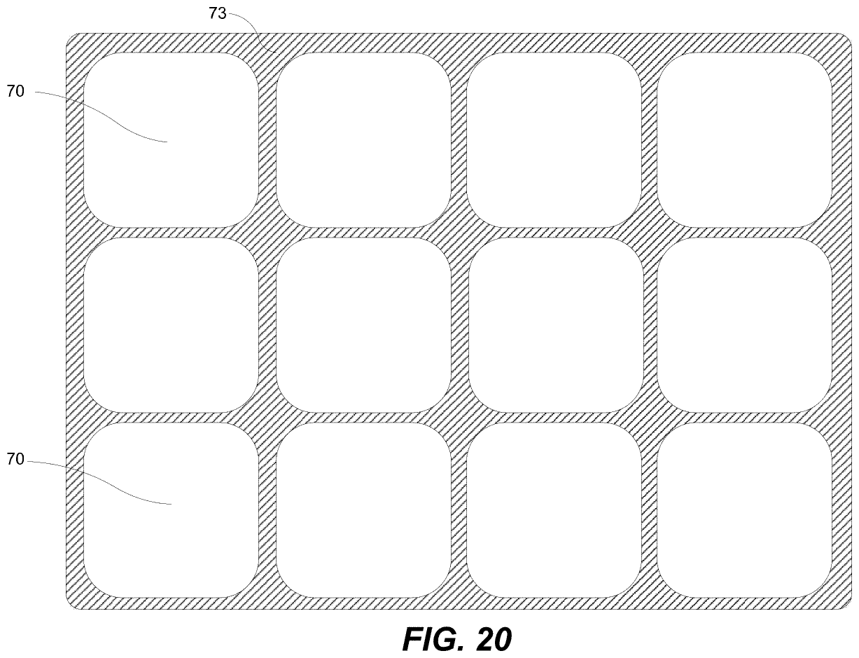

Each flock receiving channel 70 is separated from its neighbors by a distance commensurate with the maximum amount of flattening that can be tolerated. That is to say, the sections 72 of the lower mold component 14B between the channels contribute to flattening (or substantially displaced from their original generally vertical arrangement) of the flock fibers. Thus the area, defined by their top surface 73, occupied by these sections is preferably minimized while retaining sufficient supportive strength to withstand the pressure during injection. Acceptable “damage” to the fibers depends on the required specifications of the final product. For the automotive industry this may represent no more than about 10% and preferably about 1% to 5% of the fibers being flattened. This can perhaps be better appreciated by referring to FIG. 20 where a top view of the area of lower mold component 14B comprising the flock receiving channels 70 is shown. Thus the total top surface 73 would be no more than about 10% and preferably about 1% to 5% of the surface occupied by flock fibers on the tape. Less stringent product specifications may permit top surface 73 to occupy a greater total surface area. The distance (occupied by top surface 73) between any two the flock receiving channels is preferably between about 0.05 mm and 0.1 mm. FIG. 20 exemplifies a regular pattern of disposition of flock receiving channels 70 with rounded-corners squares openings but it will be appreciated that other patterns may also be used such as a honeycomb pattern or a pattern where the openings for flock receiving channels 70 are round for example. Also, the pattern need not necessarily be regular and may be designed to adapt to the shape of the substrate cavity for example. Furthermore the edges of surface 73 between channels 70 may be rounded so that the top of sections 72 is dome shaped. Such a shape may advantageously force flock fibers to deviate in one or another flock receiving channel 70 thereby further reducing flattening of the fibers.

The flock receiving channels 70 can be created with a laser. In the case of laser engraving, the channels may have a generally conical shape as illustrated in FIGS. 18A and 18B as a result of the tapering of the laser beam power along the depth of the channel. However the tapering can be controlled to provide sufficient volume to accommodate the fibers. The fibers may tolerate a certain level of crowding within the channel to the extent that they are resilient enough to regain their original orientation once the molded object is removed from the mold. Other geometries for the flock receiving channels 70 are also contemplated such as cylindrical, cubic and the like. The orientation of the channels 70 within the lower mold component 14B may depend on the shape of the substrate cavity 17. For example in FIG. 18B some of the channels are obliquely oriented to accommodate the curvature of the substrate cavity 17. Other means of creating the channels 70 include, without being limited to, electrical discharge machining (EDM), plasma cutting and the like.

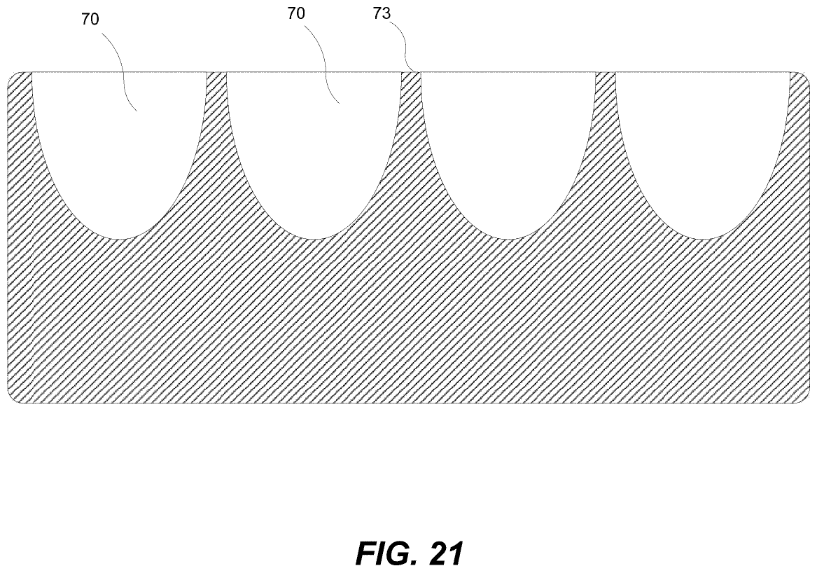

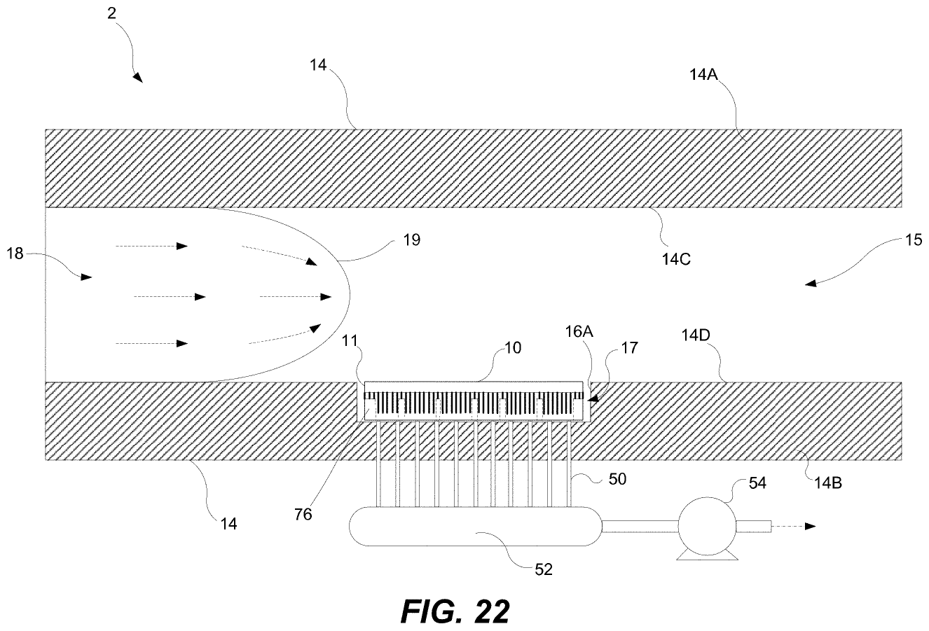

FIGS. 20 and 21 are illustrations of a mold having a plurality of conically shaped flock-receiving channels 70 that have been laser-engraved into the lower mold component 14B. The configuration (in terms of size and spacing) of the channels 70 is merely illustrative of the concept and may be varied for different operating parameters, materials, pressures, etc. and/or to achieve different results. In one specific implementation, which is presented solely to illustrate one particular configuration that is believed to provide excellent results, the height of the conically shaped channels is 0.3-0.7 mm and the width is 0.05-0.15 mm. Other geometries and dimensions may be used as further described below.

As will be appreciated, flock receiving channels that are too wide could result in a downward displacement of the tape as a result of the pressure exerted by the flow of the melted thermoset (lack of sufficient support). Thus, the size of the flock receiving channels 70 is adjusted as a function of parameters such as the substrate resiliency, pressure generated by the melted thermoset, substrate cavity size, stabilizing force exerted on the substrate and the like.

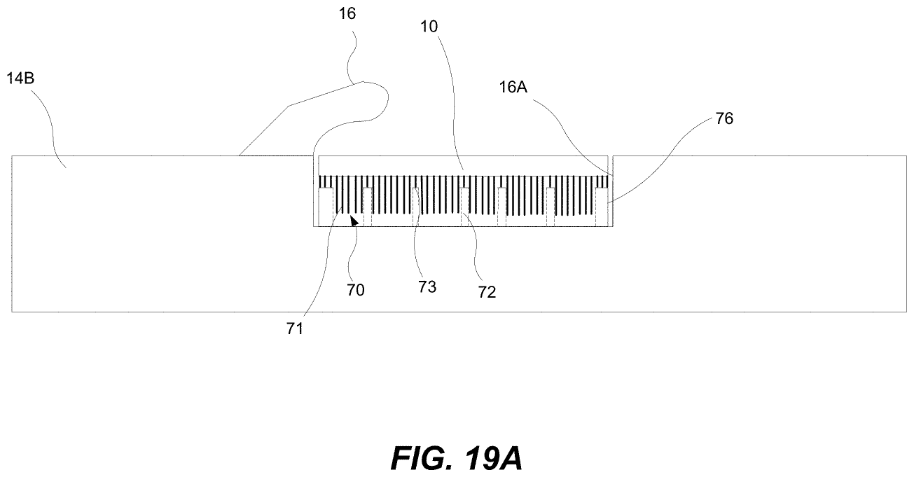

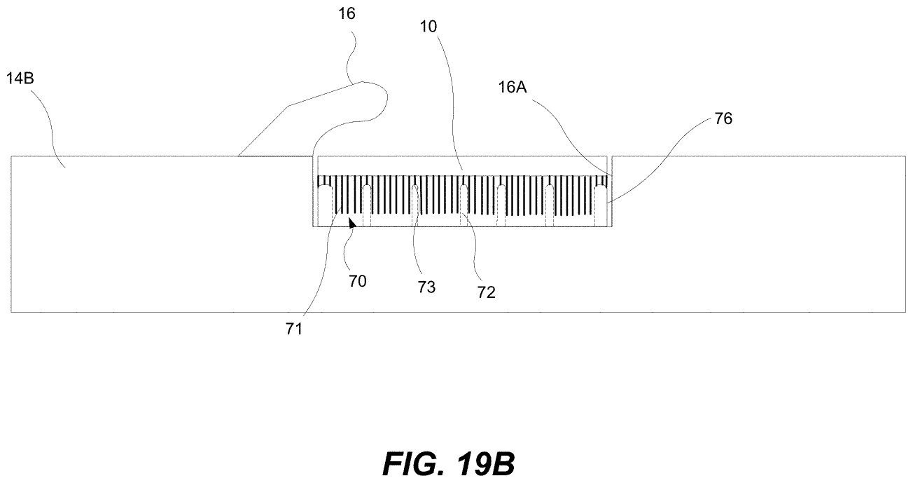

In an alternative embodiment shown in FIG. 19A, the flock receiving channels may be created with a mesh structure 76 superimposed on the lower mold component 14B or substrate cavity 17 when such a cavity is present. In this case the flock receiving channels 70 are the pores or sieves of the mesh while the strands (or sections 72) of the mesh itself provide support for the tape (or other type of substrate). Advantageously the mesh structure may be removed and replaced by a mesh of different dimension allowing the same mold to be re-used for substrates and/or flocking fibers of different dimensions. The mesh may be made of any suitable material such as metal, fiber-reinforced polymers, plastic and the like. In one advantageous embodiment, the material is one that does not bind to the thermoplastic material used for the injection.

For example the mesh could be made of a polyamide when thermoplastic vulcanizates (TPV) or polypropylene (PP) are used as thermoplastics for the injection. Thus in case of infiltration of the thermoplastic melt in the mesh it is easily cleanable.

The pores or sieves dimensions are in the same ranges as described for the flock receiving channels 70 created in the lower mold component 14B. Thus preferred size comprises mesh size of between about 100 to 300 mesh and more preferably about 150 mesh which correspond to pore or sieves size of about 0.05 mm to about 0.15 mm and more preferably about 0.1 mm. In one embodiment shown in FIG. 19B, the top surface 73 of the sections 72 of the mesh may be rounded as was described above in the case where the flock receiving channels 70 are made directly in lower mold component 14B.

The lower dimension limit for the width of flock receiving channels 70 is reached when the number of fibers per channel is too small. This lower limit ratio can be determined by taking into account the size and density of the fibers.

The mesh structure may be retained by retaining means to avoid displacement and/or facilitate the positioning of the substrate thereon. The substrate cavity 17 alone may be sufficient to that effect or may cooperate with additional retention structures.

In one aspect the flock receiving channels 70 can cooperate with the substrate stabilizing means. For example, the mesh structure may be coupled with a vacuum system. The porous nature of the mesh advantageously provides for an easy connection with a vacuum system by enabling the propagation of the vacuum and offers flexibility as to the number, size and positioning of the vacuum channels (such as vacuum channels 50) allowing strategic positioning of the vacuum channels 50 within the mold. Furthermore the suction action of the vacuum may contribute to straightening the fibers.

The flock receiving channels 70 can also contribute to the stabilization of the substrate. The fibers once inserted in the flock receiving channels 70 contribute to resist any lateral displacement of the substrate. In this respect, the flock receiving channels 70 may be sufficient, that is to say without a flow deflector, to prevent infiltration of the thermoplastic melt under the substrate without a flow deflector as shown in FIG. 22. This may be especially the case when the flock receiving channels 70 are comprised in a mesh structure and combined with a vacuum or partial vacuum. The mesh structure allows the vacuum to reach substantially all the surface of the substrate and therefore provide good stabilization of the substrate especially at the critical leading edge of the substrate.

The leading edge 11 of substrate 10 in the case of a tape such as a flock tape is typically not perfectly even and leveled sometimes exhibiting small ripples on its top surface. Thus when the substrate 10 is of the same thickness as the depth of substrate cavity 17 as shown in FIG. 22, these ripples may protrude slightly higher than surface 14D. In such a case, the flow may run into these ripples and displace the tape. However, as described above, the combination of the mesh structure and a vacuum may be sufficient to stabilize the tape by reducing the ripples and/or providing sufficient suction at the edge 11 (because of the propagation of the vacuum in the mesh to reach all the surface of the tape) to prevent the displacement by the front of the flow.

Alternatively, the flock receiving channels (created by a mesh structure or directly in lower mold component 14B) may advantageously cooperate with the flow deflector 16, the substrate cavity 17 or the retention member 16B, either separately or together, to maintain the substrate in place and prevent infiltration of the thermoset material under the substrate.

Mesh structures can be made by methods known to persons skilled in the art. More recent technologies such as 3D printing can advantageously be used.

The various mold structures and arrangements described above may be combined, adapted and/or configured to accommodate various configurations of thermoset melt injection points. For example, a single injection point may be used but a plurality (two or more) injection points can also be used such as in sequential molding techniques. It will be appreciated that the various injection point(s) configurations will results in different flow patterns and thereby requiring adaptation of the mold configuration.

Another aspect of the invention is a method for in-mold binding of a substrate on an injection-molded article. The method entails steps, acts or operations of positioning the substrate within the mold prior to injection of the molten plastic material and injecting the molten plastic material, e.g. thermoplastic, and then causing the deflection of the flow of molten plastic material inside the mold using a flow deflector to deflect the flow of molten plastic material over the leading edge of the substrate thereby preventing head-on contact between a front of the flow and the leading edge of the substrate. This method reduces the likelihood of the substrate being displaced or deformed during the molding process. As a result, the method facilitates in-mold binding of a substrate to an injection-molded article.

As will be appreciated, additional steps, acts and operations to complete the injection molding may involve a cooling cycle and removal of the molded article from the mold.

Thus, in some embodiments, the method involves positioning the substrate within an injection mold prior to injection of the molten plastic material, closing the mold while maintaining the substrate in the desired position (i.e. the finished molded object position), applying any optional stabilizing means (e.g. a vacuum) to hold the substrate in place, and injecting the molten plastic material into the mold to create a flow that is deflected by a flow deflector over the leading edge of the substrate to prevent head-on contact between a front of the flow and an edge of the substrate. In the embodiments of this method, the flow makes first contact with the upper adhering surface of the substrate downstream of the leading edge to secure the substrate in place. A temporary air pocket is formed upstream of the point of first contact. The edge directional flow then back fills the temporary air pocket while the also flow spreads forward toward the downstream edge(s) of the substrate. In other words, in some embodiments of the method, the front of the flow is directed onto a central portion or middle point of the adhering surface of the substrate away from the edge or edges of the substrate prior to allowing the flow to spread over the entire adhering surface of the substrate.

The step of deflecting the flow to prevent head-on contact between a front of the flow and an edge of the substrate is achieved using one or more flow deflectors that divert the flow of the molten plastic material such that it initially makes contact with the adhering surface of the substrate away from the edge(s) before spreading to the edge(s) of the substrate. In one aspect this may be achieved by creating a temporary dead space at or near the edge(s) of the substrate during injection to allow the flow to first contact the adhering surface centrally, i.e. away from the edge(s). By avoiding the edges, the substrate is bound in-mold to the article without the problems that affect the prior art.

The method may also involve directing the flow using one or more flow-directing structures within the mold.

Furthermore, in one embodiment of the method, the flow deflector and/or the flow-directing structure can be dynamically displaced, moved or retracted during injection or during the cooling cycle.

In some embodiments, the positional stability of the substrate 10 can be enhanced by applying a restraining or stabilizing force or pressure on the substrate 10. For example, a vacuum may be generated underneath the substrate 10 to create suction that forces the substrate 10 against the bottom of the mold. The vacuum may be applied before starting the injection, during the injection or both.

In yet a further embodiment of the method, the flow of melted thermoplastic is not deflected but the leading edge of the substrate (especially in the case of a tape) is stabilized within the substrate cavity to prevent small imperfections in the alignment of the surface of the tape with the surface of the mold cavity from being lifted or pushed by the front of the flow. The stabilizing can be done for example by using a vacuum as stabilizing force in combination with a mesh structure to support the substrate.

In another aspect there is provided a method for adjusting the texture of flock fibers on a flock tape to match the texture of flock fibers on a separate section of the finished product. Complex molded pieces may comprise a plurality of sections or parts that are manufactured separately and then assembled by various processes.

Sometimes flock tape may be applied to different sections using a different process. For example, on one part the flock tape may be applied as a secondary operation with a roll and on another it may be applied in-mold as described above. Those different processes may result in the flock fibers from different parts of the finished product having different degree of flattening which may be unacceptable or outside the specifications. The mold of at least one embodiment of the present invention enables the adjustment of the flock fibers texture or degree of flattening to match that of the flock fibers produced by another process. The matching can be accomplished by adjusting the size of surface 73 so that the amount of flattening of the flock fibers created by in-mold substrate binding will match that of the flock fibers produced by a separate manufacturing process. The mesh structure is particularly advantageous in this respect since it is easy to test several sizes of mesh until a “match” is found without having to machine the mold to create the flock receiving channels 70.

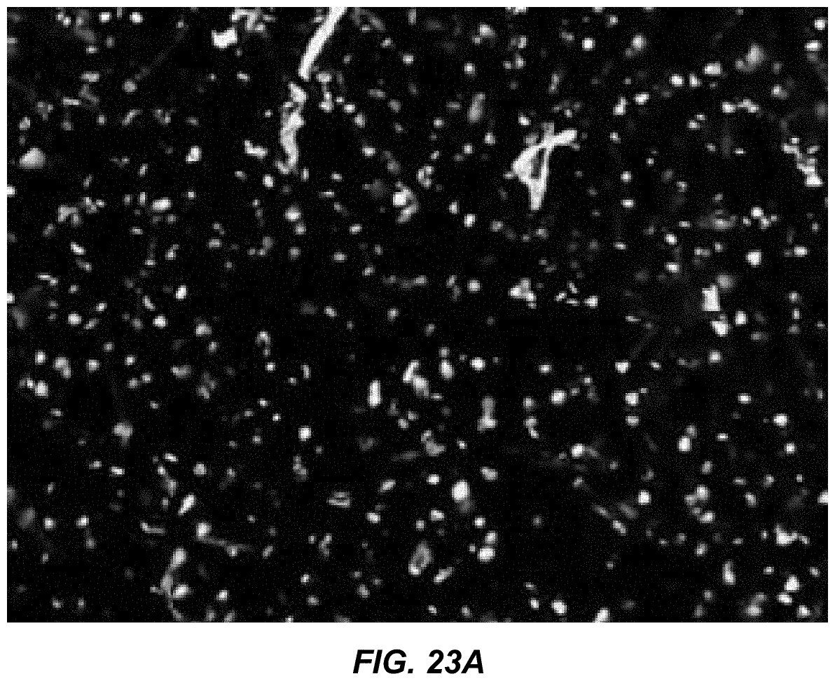

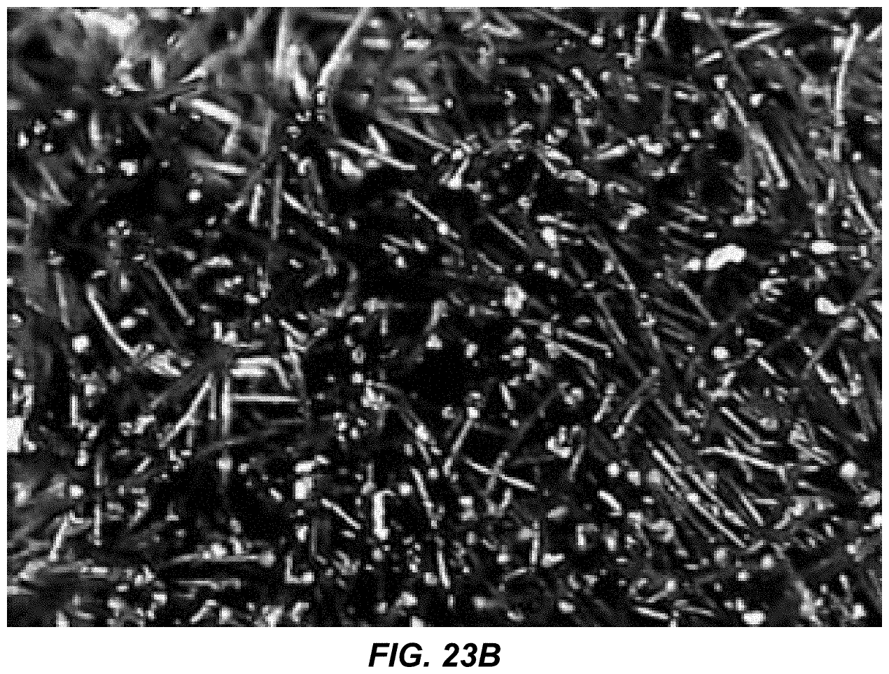

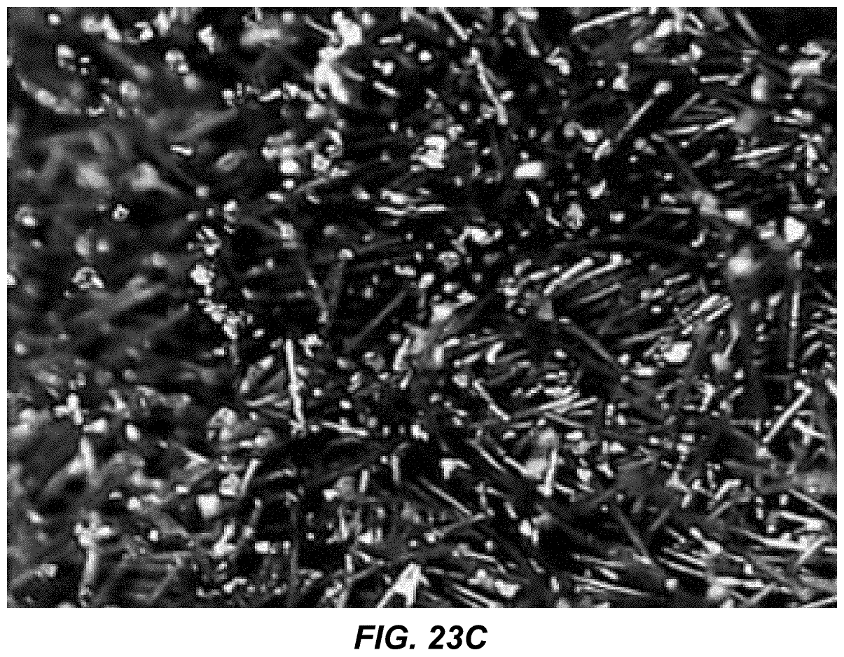

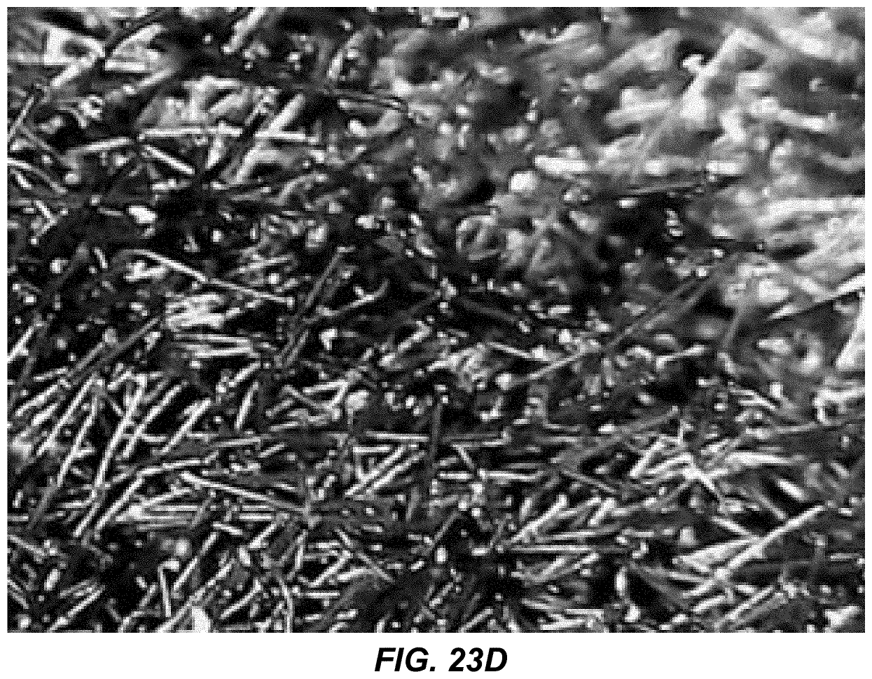

The match or the degree of flocking fibers flattening can be assessed visually by comparing the color (shade of gray on a gray scale) of the flock surface of flock tape. FIGS. 23A-D show photographs of magnified images of flock tapes that have been exposed to in-mold substrate binding while resting on meshes of different size. FIG. 23A shows a tape that has not been exposed to in-mold binding (control). FIGS. 23B, 23C and 23D show tapes that have been exposed to in-mold binding while resting on meshes with mesh sizes of approximately 150, 180 and 250 mesh respectively. The progression of increasing white speckles from 150 mesh (least) to 250 mesh (most) indicates increasing fiber flattening as the size of the pores diminishes. It will be appreciated that depending on the characteristics of the tape, such as but not limited to, fibers density, there may be an optimum size of mesh below or above which flattening may increase.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

This invention has been described in terms of specific embodiments, implementations and configurations which are intended to be exemplary only. Persons of ordinary skill in the art will appreciate, having read this disclosure, that many obvious variations, modifications and refinements may be made without departing from the inventive concept(s) presented herein. The scope of the exclusive right sought by the Applicant(s) is therefore intended to be limited solely by the appended claims.

1. An injection mold for manufacturing an injection-molded article to which a substrate is bound in-mold during injection, the substrate having an adhering surface for binding to the article and a leading edge at an upstream end of the substrate, the injection mold comprising:
a first mold component and a second mold component together defining a cavity into which a molten plastic material is injected to form the article; and
a flow deflector disposed on at least one of the first and second mold components, wherein the flow deflector deflects a flow of the molten plastic material over the leading edge of the substrate such that the flow makes first contact with the adhering surface of the substrate downstream of the leading edge, thereby forming a temporary air pocket at the leading edge of the substrate which is then back-filled by the subsequent flow of the molten plastic material.

2. The injection mold of claim 1 wherein the flow deflector comprises an overhang.

3. The injection mold of claim 1 or 2 wherein the flow deflector comprises a curved ramp.

4. The injection mold of claim 1 or 2 wherein the flow deflector comprises a linear ramp.

5. The injection mold of claim 1 wherein the flow deflector comprises an angled undercut.

6. The injection mold of claim 1 wherein the flow deflector comprises a step.

7. The injection mold of claim 1 wherein the flow deflector comprises a dual angled ramp having a first angled ramp-like portion having a first angle and a second angled ramp-like portion having a second angle different from the first angle.

8. (canceled)

9. The injection mold of claim 1 further comprising a flow-directing structure downstream of the flow deflector for directing the flow toward the substrate.

10-11. (canceled)

12. The injection mold of claim 1 wherein the lower mold component comprises a substrate cavity for receiving the substrate.

13. The injection mold of claim 1 further comprising at least one substrate stabilizer to restrain the substrate in its position in the mold.

14. The injection mold of claim 13 wherein the at least one substrate stabilizer comprises a substrate retention member.

15. (canceled)

16. The injection mold of claim 1 wherein the substrate is a flock tape and wherein the mold further comprises flock fibers protective structure.

17. The injection mold of claim 16 wherein the flocking fibers protective structure comprises flocking fibers receiving channels.

18. The injection mold of claim 17 wherein the flocking fibers protective structure is a mesh.

19. A method of injection-molding an article to which a substrate is bound in-mold during injection, the substrate having an adhering surface for binding to the article and a leading edge at an upstream end of the substrate, the method comprising:
providing a first mold component and a second mold component together defining a cavity;
injecting a molten plastic material into the cavity to form the article; and
deflecting a flow of the molten plastic material over the leading edge of the substrate using a flow deflector deflects such that the flow makes first contact with the substrate downstream of the leading edge, thereby forming a temporary air pocket at the leading edge of the substrate which is then back-filled by the subsequent flow of the molten plastic material.

20. (canceled)

21. The method of claim 19 further comprising restraining the substrate using at least one substrate stabilizer.

22. (canceled)

23. The method of claim 19 further directing the flow toward the substrate using a flow-directing structure downstream of the flow deflector.

24-26. (canceled)

27. The method of claim 19 wherein the substrate is a tape.

28. The method of claim 27 wherein the tape comprises flock fibers.

29. The method of claim 28 wherein the substrate is restrained by at least one substrate stabilizer and wherein the at least one substrate stabilizer comprises flock receiving channels whereby insertion of the flock fibers in the flock receiving channels prevent displacement of the tape during injection.

30-36. (canceled)
